(19) United States
(12) Patent Application Publication
(10) Pub. No.: US 2020/0216253 A1
(43) Pub. Date: Jul. 9, 2020

(54) CONTAINER AND TEMPERATURE CONTROL SYSTEM

(71) Applicant: HITACHI HIGH-TECHNOLOGIES CORPORATION, Tokyo (JP)

(72) Inventors: Toru TANABE, Santa Clara, CA (US); Nobuya HORIKOSHI, Tokyo (JP)

(21) Appl. No.: 16/239,639

(22) Filed: Jan. 4, 2019

(51) Int. Cl. B65D 81/18; G05B 15/02; B65D 81/38

(52) U.S. Cl. CPC B65D 81/18; H04B 7/26; B65D 81/3823; G05B 15/02

(57) ABSTRACT

It is an object to simply control an internal temperature of each individual container. A container comprises a cover portion; a box body including; a containing space formed therein; and an opening surface openable and closable by the cover portion; and a recording device including: a storage unit storing measurement information containing an internal temperature of the containing space and time when measuring the temperature; and a communication unit transmitting the measurement information to an external device, the recording device being provided in the cover portion, or the box body, or within the containing space, outside surfaces of the cover portion and the box body being covered with a metallic material to block communications between the communication unit and the external device, the metallic material used blocking of the communications between the communication unit and the external device being cancelled upon opening the cover portion.

### FIELD

The present invention pertains to a container and a temperature control system.

### BACKGROUND

There is growing importance of quality management of foods due to enforcement of Food Safety Modernization Act (FSMA) of U.S.A. One of items of the quality management of the foods is temperature control.

### [Patent Document 1] Japanese Patent Application Laid-Open Publication No. 2001-206452

### SUMMARY

It is requested to control about what state of temperature foods are kept in within a cooling box when putting the foods into the cooling box (container) and transporting the foods to a destination by a transport truck and other equivalent vehicles. Normally, a transporter is burdened with such an excessive load as to control internal temperatures of a multiplicity of cooling boxes to be transported. Such being the case, it is required to control the internal temperature of each cooling box without imposing the excessive load on the transporter.

It is considered that the temperature is controlled by installing a temperature logger within a transport truck for transporting the cooling box, and an internal temperature of the transport truck is not necessarily uniform but is different from an internal temperature of the cooling box as the case may be.

It is an object of the present invention to simply control an internal temperature of each individual container.

Means given below are adopted for solving the problems described above.

To be specific, a first aspect is a container having:

a cover portion;

a box body including; a containing space formed therein; and an opening surface openable and closable by the cover portion; and

a recording device including: a storage unit storing measurement information containing an internal temperature of the containing space and time when measuring the temperature; and a communication unit transmitting the measurement information to an external device, the recording device being provided in the cover portion or the box body, or within the containing space,

outside surfaces of the cover portion and the box body being covered with a metallic material to block communications between the communication unit and the external device,

the metallic material enabling the communications between the communication unit and the external device being cancelled upon opening the cover portion.

The aspect of the disclosure may also be attained in such a way that an information processing apparatus runs programs. In other words, a configuration of the disclosure may be specified as a program for making the information processing apparatus execute processes to be executed the respective means in the aspect described above, or as a non-transitory computer readable recording medium recorded with the program. The configuration of the disclosure may also be specified as a method by which the information processing apparatus executes the processes to be executed by the respective means. The configuration of the disclosure may further be specified as a system including the information processing apparatus that executes the processes to be executed by the respective means.

Steps to describe the program include, as a matter of course, processes to be executed in time-series along a written sequence, and also include processes that are not necessarily executed in time-series but in parallel or individually. Apart of the steps to describe the program may be omitted.

According to the present invention, it is feasible to simply control the internal temperature of the container.

### BRIEF DESCRIPTION OF THE DRAWINGS

FIG. 1 is a diagram illustrating an example of a configuration of a temperature control system according to an embodiment;

FIG. 2 is a diagram illustrating an example of a configuration of function blocks of a user terminal;

FIG. 3 a view illustrating an example of a configuration of a cooling box;

FIG. 4 is a view illustrating an example of a state of opening a cover of the cooling box;

FIG. 5 is a view illustrating an example of a configuration of one surface portion of the cooling box;

FIG. 6 is a diagram illustrating an example of a configuration of function blocks of a temperature logger;

FIG. 7 is a view illustrating an example of a sectional view of the cooling box including the temperature logger;

FIG. 8 is a diagram illustrating an example of a hardware configuration of a computer;

FIG. 9 is a sequence chart illustrating an example of an operation sequence of a temperature control system according to the embodiment;

FIG. 10 is a flowchart illustrating an example of an operation flow of a user terminal; and

FIG. 11 is a flowchart illustrating an example of an operation flow of the temperature logger.

### EMBODIMENTS

An embodiment will hereinafter be described with reference to the drawings. A configuration of the embodiment is an exemplification, and a configuration of the invention is not limited to a specific configuration of the embodiment of the disclosure. A specific configuration corresponding to the embodiment may be properly adopted on the occasion of carrying out the invention.

### Embodiment

### Example of Configuration

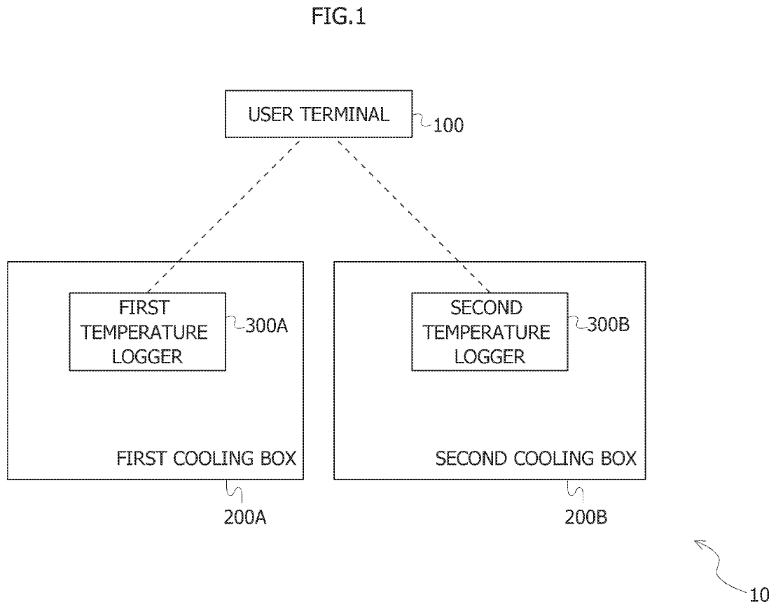

FIG. 1 is a diagram illustrating an example of a configuration of a temperature control system according to the embodiment. A temperature control system 10 in FIG. 1 includes a user terminal 100, a first cooling box 200A, a second cooling box 200B, a first temperature logger 300A, and a second temperature logger 300B. The first temperature logger 300A is installed inside the first cooling box 200A. The second temperature logger 300B is installed inside the second cooling box 200B. The first cooling box 200A and the second cooling box 200B have the same configuration. The respective cooling boxes may be, when not distinguished therebetween, simply referred to as the cooling boxes 200. The first temperature logger 300A and the second temperature logger 300B have the same configuration. The first temperature logger 300A and the second temperature logger 300B may be, when not distinguished therebetween, simply referred to as the temperature loggers 300. The cooling boxes 200 and the temperature loggers 300 may also be generically termed the cooling boxes. The user terminal 100 may also be connected to other information processing apparatuses instanced by servers via a network and other equivalent intermediaries. Herein, the 2 sets of cooling box 200 and the temperature logger 300 are provided, and numbers of the cooling boxes 200 and the temperature loggers 300 may not, however, be limited to these numerical values. The cooling box 200 has inside a containing space for containing foods and other equivalent items. The cooling box 200 is one example of a “container”. The temperature logger 300 is one example of a “recording device”.

The cooling box 200 is capable of containing the foods and other equivalent items required to be controlled in temperature inside. The cooling box 200 containing the foods and other equivalent items is transported by being loaded into a container of a transport truck. The temperature logger 300 measures and records an internal temperature of the cooling box 200. The temperature logger 300 transmits data of the recorded temperature to the user terminal 100. The user terminal 100 carried by a driver to transport the cooling box acquires from the temperature logger 300 the internal temperature data, recorded by the temperature logger 300, of the cooling box, and records the acquired data. The driver stores the foods and other equivalent items in the cooling box 200, loads the cooling box 200 on the transport truck, and transports and hands over the foods and other equivalent items to a predetermined recipient by taking the foods and other equivalent items out of the cooling box 200.

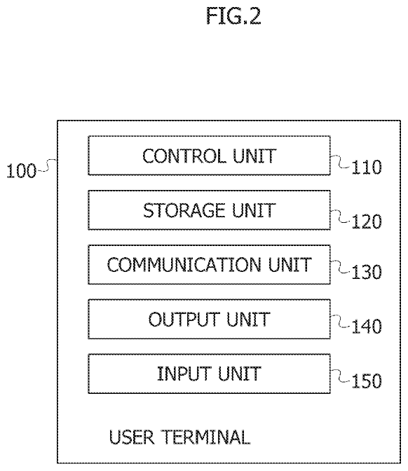

FIG. 2 is a diagram illustrating an example of a configuration of function blocks of the user terminal. The user terminal 100 includes a control unit 110, a storage unit 120, a communication unit 130, an output unit 140, and an input unit 150.

The control unit 110 acquires, from the storage unit 120, the time-based temperature data obtained from the temperature logger 300.

The storage unit 120 stores data, tables, programs and other equivalent pieces of software used by the user terminal 100. The storage unit 120 stores the data indicating the temperature obtained from each temperature logger 300. The storage unit 120 stores the data indicating the temperature by being associated with data of time when measuring the temperature (measurement time) and an identifier for identifying the temperature logger 300.

The communication unit 130 transmits and receives (performs communications of) the data and signals to and from other devices instanced by the temperature logger 300 via the network. The communication unit 130 receives the identifier of the temperature logger 300 from the temperature logger 300. The communication unit 130 requests the temperature logger 300 to transmit measurement information containing the temperature data. Communications between the user terminal 100 and the temperature logger 300 involve using wireless communications instanced by Bluetooth (registered trademark)). The communications between the user terminal 100 and the temperature logger 300 may also involve using other communication methods.

The communication unit 130 establishes a connection with a server (unillustrated) or another equivalent apparatus via the network and transmits the data of the temperature and other equivalent data acquired from the temperature logger 300 to the server, and the server may save the transmitted data.

The output unit 140 includes a display for displaying the acquired temperature data to a user of the user terminal 100.

The input unit 150 includes an input means to accept an input of an identifier for identifying the cooling box 200 and inputs of identifiers for identifying the foods and other equivalent items being put into the cooling box 200. The input means is exemplified by a keyboard, a pointing device, a touch panel and a bar code reader.

The user terminal 100 may be attained by using a dedicated or general-purpose computer instanced by a PC (Personal Computer), a smartphone, a mobile phone, a tablet terminal, a car navigation system, a PDA (Personal Digital Assistant), a workstation (WS, Work Station), or using an electronic equipment mounted with the computer.

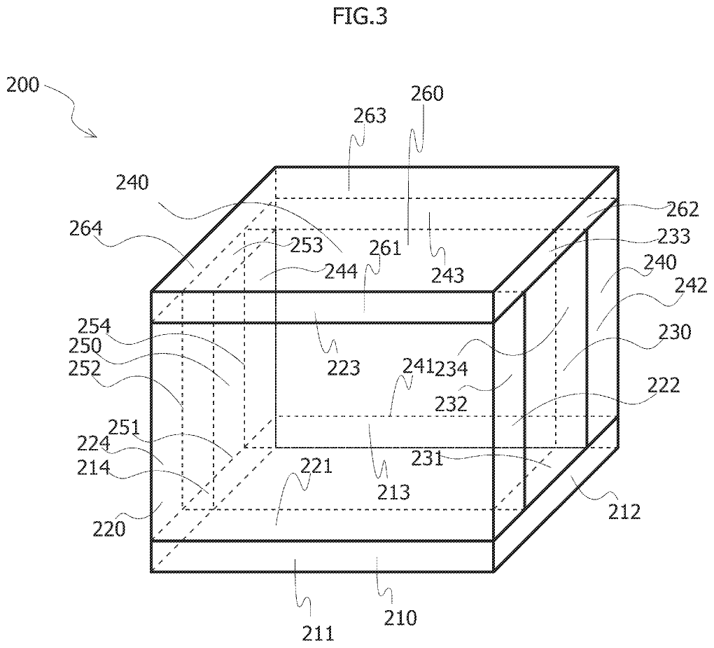

FIG. 3 is a view illustrating an example of a configuration of the cooling box. The cooling box 200 takes a rectangular parallelepiped as an external shape, and has a rectangular parallelepiped space for containing the foods and other equivalent items inside. The cooling box 200 includes a bottom surface portion 210, a front surface portion 220, a right side surface portion 230, a back surface portion 240, a left side surface portion 250, and an upper surface portion 260. Each of the bottom surface portion 210, the front surface portion 220, the right side surface portion 230, the back surface portion 240, the left side surface portion 250, and the upper surface portion 260 takes a rectangular plate shape. Each of the bottom surface portion 210, the front surface portion 220, the right side surface portion 230, the back surface portion 240, the left side surface portion 250, and the upper surface portion 260 is one example of a “heat insulating board”. The bottom surface portion 210 includes a front edge portion 211, a right edge portion 212, a rear edge portion 213, and a left edge portion 214. The front edge portion 211 and the rear edge portion 213 are the edge portions having a face-to-face relationship with each other. The right edge portion 212 and the left edge portion 214 are the edge portions having the face-to-face relationship. The front surface portion 220 includes a lower edge portion 221, a right edge portion 222, an upper edge portion 223, and a left edge portion 224. The lower edge portion 221 and the upper edge portion 223 are the edge portions having the face-to-face relationship. The right edge portion 222 and the left edge portion 224 are the edge portions having the face-to-face relationship. The right side surface portion 230 includes a lower edge portion 231, a front edge portion 232, an upper edge portion 233, and a rear edge portion 234. The lower edge portion 231 and the upper edge portion 233 are the edge portions having the face-to-face relationship. The front edge portion 232 and the rear edge portion 234 are the edge portions having the face-to-face relationship. The back surface portion 240 includes a lower edge portion 241, a right edge portion 242, an upper edge portion 243, and a left edge portion 244. The lower edge portion 241 and the upper edge portion 243 are the edge portions having the face-to-face relationship. The right edge portion 242 and the left edge portion 244 are the edge portions having the face-to-face relationship. The left side surface portion 250 includes a lower edge portion 251, a front edge portion 252, an upper edge portion 253, and a rear edge portion 254. The lower edge portion 251 and the upper edge portion 253 are the edge portions having the face-to-face relationship. The front edge portion 252 and the rear edge portion 254 are the edge portions having the face-to-face relationship. The upper surface portion 260 includes a front edge portion 261, a right edge portion 262, a rear edge portion 263, and a left edge portion 264. The front edge portion 261 and the rear edge portion 263 are the edge portions having the face-to-face relationship. The right edge portion 262 and the left edge portion 264 are the edge portions having the face-to-face relationship.

Herein, the cooling box takes the rectangular parallelepiped shape, and may also take other shapes (e.g., a triangular pole shape and a cylindrical shape). It is preferable that the bottom surface portion 210 is parallel with the upper surface portion 260. The parallelism between the bottom surface portion 210 and the upper surface portion 260 enables the cooling boxes 200 to be stacked.

The front surface portion 220 connects to the lower edge portion 221 of the front surface portion 220 on the side of the front edge portion 211 of an internal surface (on the side of a containing space of the cooling box 200) of the bottom surface portion 210, and stands erect with respect to the bottom surface portion 210. The right side surface portion 230 connects to the lower edge portion 231 of the right side surface portion 230 on the side of the right edge portion 212 of the internal surface of the bottom surface portion 210, and stands erect with respect to the bottom surface portion 210. The back surface portion 240 connects to the lower edge portion 241 of the back surface portion 240 on the side of the rear edge portion 213 of the internal surface of the bottom surface portion 210, and stands erect with respect to the bottom surface portion 210. The left side surface portion 250 connects to the lower edge portion 251 of the left side surface portion 250 on the side of the left edge portion 214 of the internal surface of the bottom surface portion 210, and stands erect with respect to the bottom surface portion 210. The front surface portion 220 and the back surface portion 240 have the face-to-face relationship, and the right side surface portion 230 and the left side surface portion 250 have the face-to-face relationship. The front surface portion 220 is contiguous to the upper edge portion 223 of the front surface portion 220 on the side of the front edge portion 261 of the internal surface of the upper surface portion 260. The right side surface portion 230 is contiguous to the upper edge portion 233 of the right side surface portion 230 on the side of the right edge portion 262 of the internal surface of the upper surface portion 260. The back surface portion 240 is contiguous to the upper edge portion 243 of the back surface portion 240 on the side of the rear edge portion 263 of the internal surface of the upper surface portion 260. The left side surface portion 250 is contiguous to the upper edge portion 253 of the left side surface portion 250 on the side of the left edge portion 264 of the internal surface of the upper surface portion 260. The bottom surface portion 210, the front surface portion 220, the right side surface portion 230, the back surface portion 240 and the left side surface portion 250 are one example of a “box body”. The bottom surface portion 210, the front surface portion 220, the right side surface portion 230, the back surface portion 240 and the left side surface portion 250 are one example of wall portions of the box body. The upper surface portion 260 is one example of a “cover portion”. The upper edge portion 223 of the front surface portion 220, the upper edge portion 233 of the right side surface portion 230, the upper edge portion 243 of the back surface portion 240 and the upper edge portion 253 of the left side surface portion 250 are one example of “edge surfaces” that form an opening of an opening surface of the box body.

The upper surface portion 260 turns about the rear edge portion 263 serving as an axis and connecting to the upper edge portion 243 of the back surface portion 240, and functions as a cover of the cooling box 200. When the front edge portion 261 of the upper surface portion 260 is positioned at the upper edge portion 223 of the front surface portion 220, a state is such that the cover of the cooling box 200 is closed. Whereas when the front edge portion 261 of the upper surface portion 260 is not positioned at the upper edge portion 223 of the front surface portion 220, the state is such that the cover of the cooling box 200 is opened. The upper surface portion 260 may be separated from other portions (the bottom surface portion 210, the front surface portion 220, the right side surface portion 230, the back surface portion 240, and the left side surface portion 250).

The cooling box 200 contains a predetermined refrigerant in order to keep an interior of the cooling box 200 in a predetermined temperature area. The interior of the cooling box 200 may be provided with a pocket for storing the predetermined refrigerant.

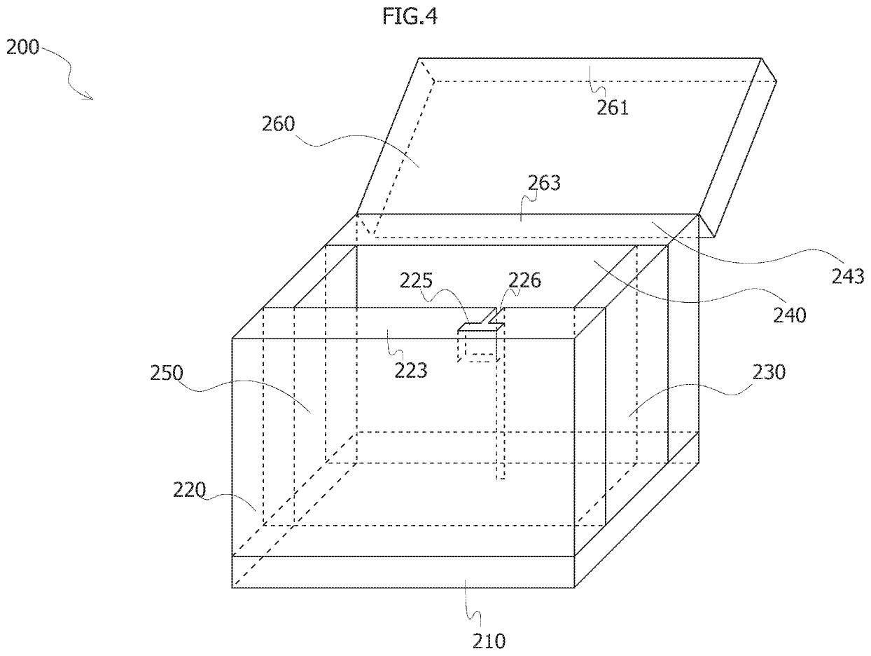

FIG. 4 is a view illustrating an example of the state of opening the cover of the cooling box. In the example of FIG. 4, the rear edge portion 263 of the upper surface portion 260 of the cooling box 200 is connected to an external surface of the back surface portion 240. The upper surface portion 260 turns about this connected portion serving as the axis, and becomes a state in which a surface, on the side of the containing space, of the upper surface portion 260 is separated from the upper edge portion 223 of the front surface portion 220. The front surface portion 220 is provided with a recessed portion 225 and a hole portion 226. The recessed portion 225 and the hole portion 226 are generically referred to as a groove portion. The recessed portion 225 receives the body unit of the temperature logger 300, and is therefore a portion that is enlarged more than the hole portion 226. The groove portion configures a hole-shaped channel communicating with the containing space from the upper edge portion 223 of the front surface portion 220. The recessed portion 225 and the hole portion 226 are defined as a space for receiving the temperature logger 300. The temperature logger 300 is fixed to the recessed portion 225 and the hole portion 226. The recessed portion 225 to receive the temperature logger 300 is provided in the upper edge portion 223, thereby making it easy to take out and receive the temperature logger 300.

The recessed portion 225 and the hole portion 226 are herein assumed to be provided in the front surface portion 220, and may also be provided in the right side surface portion 230, the back surface portion 240, the left side surface portion 250, or the upper surface portion 260. It may be sufficient that the recessed portion 225 and the hole portion 226 are provided in positions enabling the temperature logger 300 to communicate with devices outside the cooling box 200 when opening the cover of the cooling box 200.

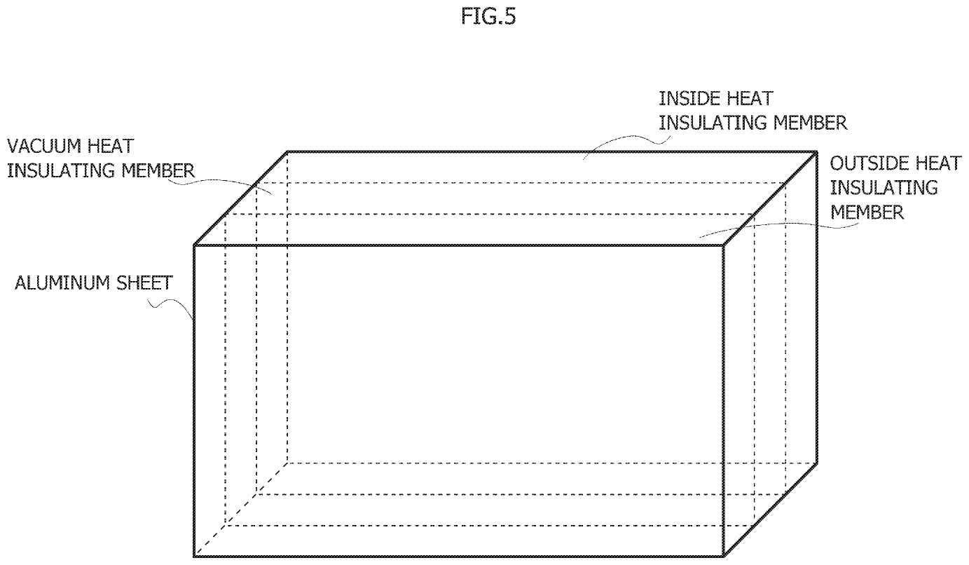

FIG. 5 is a view illustrating an example of a configuration of one surface portion of the cooling box. Each of the surface portions of the cooling box 200 takes a plate-like shape. Each of the surface portions of the cooling box 200 includes a plate-shaped inside heat insulating member, a vacuum heat insulating member, a plate-shaped outside heat insulating member, and an aluminum sheet. Other metallic sheets may also be used in place of the aluminum sheet. The aluminum sheet and the metallic sheet are one example of “metallic materials”. The vacuum heat insulating member of each surface portion is fixed by being pinched between the inside heat insulating member and the outside heat insulating member. Each surface portion including the inside heat insulating member, the vacuum heat insulating member and the outside heat insulating member is covered with the aluminum sheet on the whole. The inside heat insulating member is disposed inwardly of the cooling box 200. The outside heat insulating member is disposed outwardly of the cooling box 200. The inside heat insulating member, the vacuum heat insulating member and the outside heat insulating member are also generically termed a heat insulating member. The heat insulating member has a 3-layered structure of the inside heat insulating member, the vacuum heat insulating member and the outside heat insulating member toward the outside from the inside (containing space side) of the cooling box 200. The plate-shaped heat insulating member thermally insulates an area between one surface and the other surface. Each of the surface portions of the cooling box 200 is not limited to the plate-shaped heat insulating member having the 3-layered structure described herein, but may involve using heat insulating members having other structures. Each of the surface portions of the cooling box 200 may also be covered with the metallic sheet with respect to only the portion becoming the external surface of the cooling box 200.

The inside heat insulating member and the outside heat insulating member are, e.g., plate-shaped foamed resins instanced by foamed polystyrene and foamed urethan. Other heat insulating materials may also be used as substitutes for the foamed resin. The heat insulating member is a non-metallic member. The vacuum heat insulating member is a plate-shaped metallic member having a tightly closed space inside. The internal tightly closed space of the vacuum heat insulating member is a pre-evacuated vacuum layer. The vacuum heat insulating member includes the vacuum layer. The vacuum heat insulating member has the internal vacuum tightly-closed space, thereby thermally insulating an area between the inside heat insulating member and the outside heat insulating member. A periphery of the vacuum heat insulating member of each surface portion may be covered with the same heat insulating material as the inside heat insulating member.

The recessed portion 225 of the front surface portion 220 is provided in the outside heat insulating member of the front surface portion 220. The recessed portion 225 of the front surface portion 220 is provided on the side of the upper edge portion 223 of the front surface portion 220. The hole portion 226 is provided over the periphery of the vacuum heat insulating member of the front surface portion 220 and the inside heat insulating member in extension from the recessed portion 225. The recessed portion 225 and the hole portion 226 communicate with each other. The recessed portion 225 and the hole portion 226 are provided in a way of not interfering with the vacuum heat insulating member.

The cooling box 200 may be configured to be folded compactly when not used.

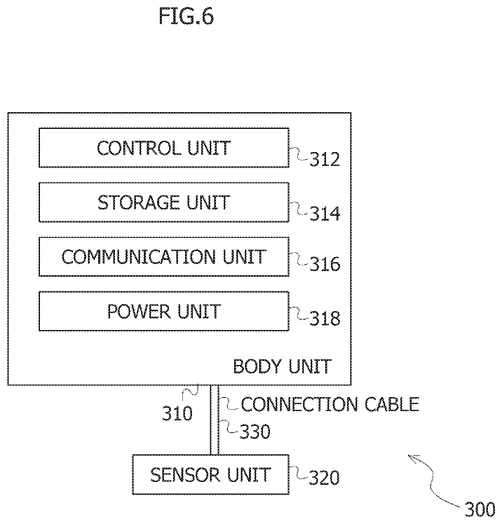

FIG. 6 is a diagram illustrating an example of a configuration of function blocks of the temperature logger. The temperature logger 300 includes a body unit 310, a sensor unit 320, and a connection cable 330 for connecting the body unit 310 to the sensor unit 320. The body unit 310 includes a control unit 312, a storage unit 314, a communication unit 316, and a power unit 318. The temperature logger 300 is installed in the recessed portion 225 and the hole portion 226 of the front surface portion 220 of the cooling box 200. The temperature logger 300 is a data logger to record a temperature measured by a temperature sensor. A logger is also called a recorder or a data recorder.

The control unit 312 acquires an ambient temperature (temperature) from the sensor unit 320. The control unit 312 stores the acquired temperature as measurement information in the storage unit 314 by being associated with time information. The control unit 312 may delete the oldest temperature data stored in the storage unit 314 when new temperature data is unable to be stored in the storage unit 314 due to an excess over a capacity of the storage unit 314.

The storage unit 314 stores the data, the tables, the programs and other equivalent pieces of software used by the temperature logger 300. The storage unit 314 stores a unique identifier for identifying the temperature logger 300. The storage unit 314 stores the temperature data measured by the sensor unit 320.

The communication unit 316 transmits and receives (performs the communications with) the data and the signals to and from the user terminal 100. The communication unit 316 transmits the identifier of the temperature logger 300 toward the user terminal 100. The communication unit 316 receives a request for transmitting the measurement information containing the temperature data from the user terminal 100. The communication unit 316 transmits the measurement information containing the temperature data to the user terminal 100. The communication unit 316 is connected to the sensor unit 320 via the connection cable 330, and receives the temperature measured by the sensor unit 320.

The power unit 318 is a power source for actuating the temperature logger 300. The power unit 318 is, e.g., a primary battery, a secondary battery and one of other equivalent batteries. The power unit 318 supplies the temperature logger 300 with electric power.

The sensor unit 320 is a temperature sensor to measure the ambient temperature at an interval of predetermined time or consecutively. The sensor unit 320 is, e.g., a thermo couple. The sensor unit 320 may also involve using other types of temperature sensors. The sensor unit 320 is connected to the body unit 310 via the connection cable 330.

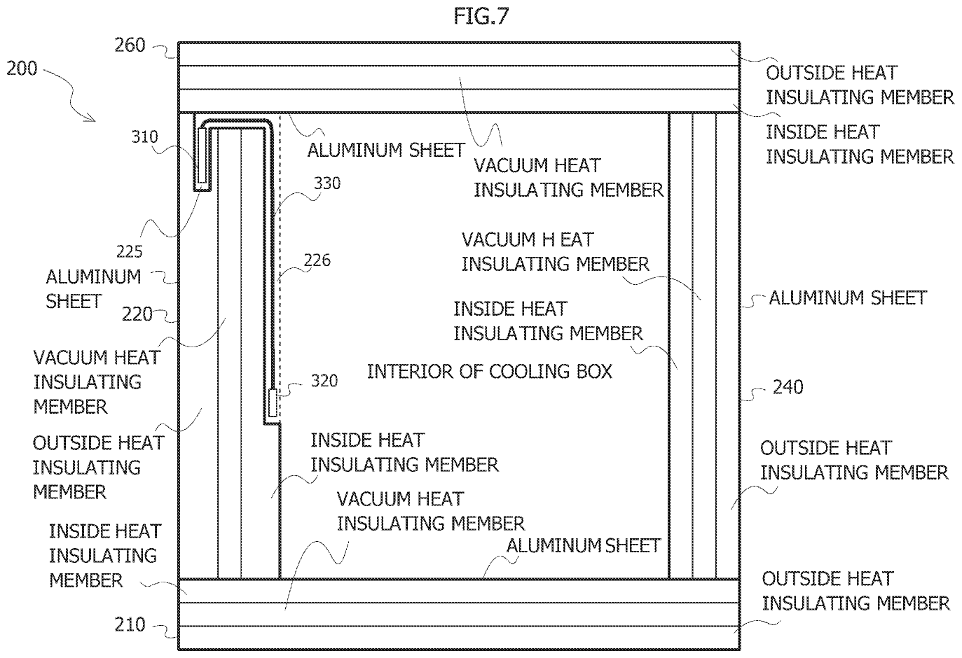

FIG. 7 is a view illustrating an example of a sectional view of the cooling box including the temperature logger. In the sectional view of FIG. 7, the front surface portion 220 and the back surface portion 240 stand erect in the face-to-face relationship at both edges of the bottom surface portion 210, and the upper surface portion 260 is placed on the front surface portion 220 and the back surface portion 240. The cooling box 200 in FIG. 7 is in a state of the cover (the upper surface portion 260) being closed. Each surface portion includes the inside heat insulating member, the vacuum heat insulating member and the outside heat insulating member. The outside heat insulating member of the front surface portion 220 is provided with the recessed portion 225, and the hole portion 226 is provided in the upper edge of the vacuum heat insulating member of the front surface portion 220 and the inside heat insulating member. The recessed portion 225 receives the body unit 310 of the temperature logger 300, and the hole portion 226 receives the sensor unit 320 of the temperature logger 300 and the connection cable 330. The sensor unit 320 faces the interior of the cooling box 200. The temperature logger 300 is attachable to and detachable from the cooling box 200.

A periphery of the cooling box 200 is covered with the aluminum sheet. In the state where the cover of the cooling box 200 is closed, the signals transmitted from the temperature logger 300 are blocked by the aluminum sheet but do not reach the devices (the user terminal 100 and other equivalent devices) outside the cooling box 200. In other words, the communications between the temperature logger 300 and the user terminal 100 are blocked. On the other hand, in the state of opening the cover of the cooling box 200, the signals transmitted from the temperature logger 300 are enabled to reach the devices (the user terminal 100 and other equivalent devices) outside the cooling box 200. In other words, the blocking of the communications between the temperature logger 300 and the user terminal 100 is cancelled. The body unit 310 is disposed within the outside heat insulating member (outside the vacuum heat insulating member) and is thereby hard to be affected by the internal temperature of the cooling box 200. The body unit 310 includes the power unit 318, and it is therefore desirable that the temperature decreases (under, e.g., −10° C.). This is because performance of the power unit 318 decreases as the temperature becomes lower.

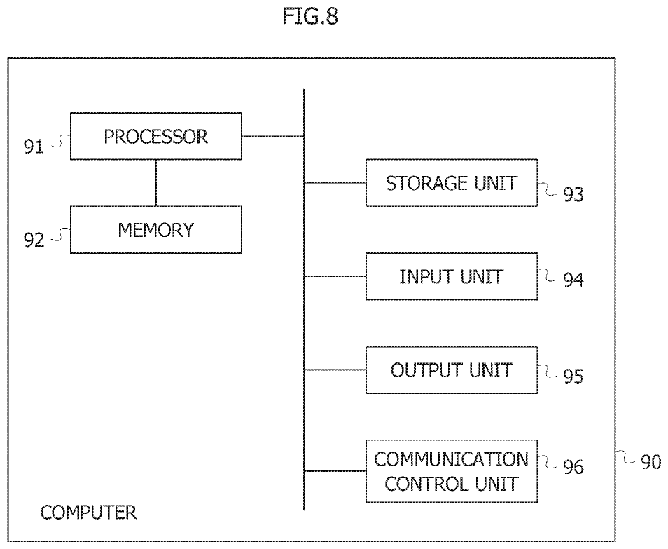

FIG. 8 is a diagram illustrating an example of a hardware configuration of a computer. The computer depicted in FIG. 8 has a configuration of a general type of computer. The user terminal 100 and the temperature logger 300 are attained by a computer 90 as illustrated in FIG. 8. The computer 90 in FIG. 8 includes a processor 91, a memory 92, a storage unit 93, an input unit 94, an output unit 95, and a communication control unit 96. The memory 92 is connected directly to the processor 91, and the components other than the memory 92 are interconnected via a bus. The storage unit 93 is a non-transitory computer readable recording medium. The hardware configuration of the computer is not limited to the example depicted in FIG. 8, but the components may be properly omitted, replaced and added.

The processor 91 loads programs, various items of data and various types of tables, which are stored on the recording medium, into a working area of the memory 92 and runs the programs, and the respective components are controlled through running the programs, whereby the computer 90 is enabled to attain functions matching with predetermined purposes.

The processor 91 is, e.g., a CPU (Central Processing Unit) or a DSP (Digital Signal Processor).

The memory 92 includes, a RAM (Random Access Memory) and a ROM (Read Only Memory). The memory 92 is also called a main storage device.

The storage unit 93 is, e.g., an EPROM (Erasable Programmable ROM) or a hard disk drive (HDD, Hard Disk Drive). The storage unit 93 may include a removable medium, i.e., a portable recording medium. The removable medium is a disc recording medium instanced by a USB (Universal Serial Bus) memory, a CD (Compact Disc), or a DVD (Digital Versatile Disc). The storage unit 93 is also called a secondary storage device.

The storage unit 93 stores the various categories of programs, the various items of data and the various types of tables in a readable/writable manner. The storage unit 93 stores an operating system (Operating System: OS), the various categories of programs and the various types of tables. Information stored in the storage unit 93 may also be stored in the memory 92. Information stored in the memory 92 may also be stored in the storage unit 93.

The OS is software operating as an intermediary between the software and the hardware, and for managing a memory space, files, processes and tasks. The OS includes a communication interface. The OS includes a communication interface. The communication interface is a program for transmitting and receiving the data to and from other external devices connected via the communication control unit 96. The external devices embrace, e.g., other computers, external storage devices and other equivalent devices.

The input unit 94 includes a keyboard, a pointing device, a wireless remote controller, a touch panel and other equivalent devices. The input unit 94 may also include a video/image input device instanced by a camera, and a voice/sound input device instanced by a microphone.

The output unit 95 includes a display device instanced by an LCD (Liquid Crystal Display), an EL (Electroluminescence) panel, a CRT (Cathode Ray Tube) display and a PDP (Plasma Display Panel), and an output device instanced by a printer. The output unit 95 may also include a voice/sound output device instanced by a loudspeaker.

The communication control unit 96 establishes connections to other apparatuses and controls communications between the computer 90 and other apparatuses. The communication control unit 96 is instanced by a LAN (Local Area Network) interface board, a wireless communication circuit for wireless communications, and a communication circuit for wired communications. The LAN interface board and the wireless communication circuit are connected to a network exemplified by the Internet.

The processor loads programs stored in an auxiliary storage device into the main storage device and runs the programs, whereby the computer to attain the user terminal 100 implements functions as the respective function units. The storage unit of the user terminal 100 is provided in a storage area of the main storage device or the auxiliary storage device.

The processor loads programs stored in the auxiliary storage device into the main storage device and runs the programs, whereby the computer to attain the temperature logger 300 implements functions as the respective function units. On the other hand, the storage unit of the temperature logger 300 is provided in a storage area of the main storage device or the auxiliary storage device.

### Operational Example

<Operation of Temperature Control System>

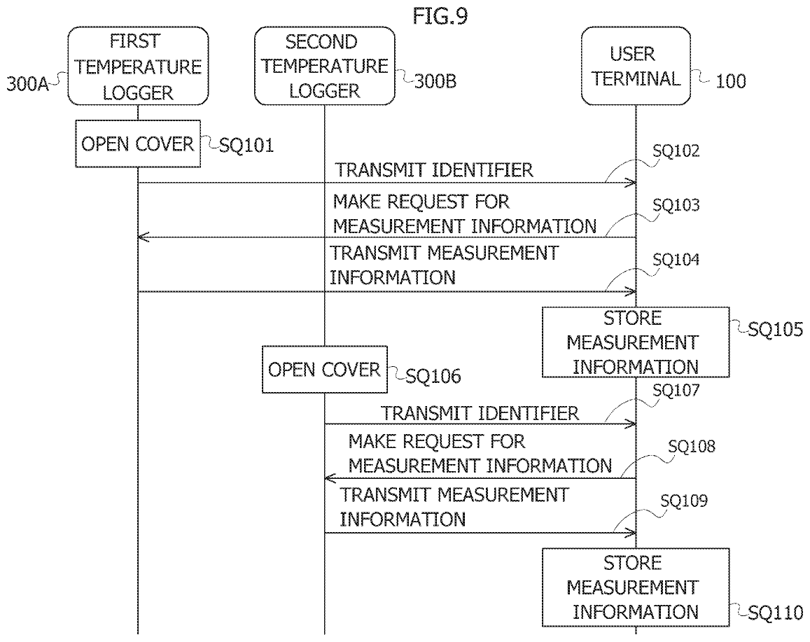

FIG. 9 is a sequence chart illustrating an example of an operation sequence of the temperature control system according to the embodiment. In a temperature control system 10, the first temperature logger 300A is installed within the first cooling box 200A, and the second temperature logger 300B is installed within the second cooling box 200B. The respective temperature loggers 300 continuously transmit the signals containing the self-identifiers. When the cover of the cooling box 200 is closed, the user terminal 100 does not receive the signal transmitted from the temperature logger 300. The user terminal 100 is carried by the user who opens and closes the cover of the cooling box 200. In the temperature logger 300, the sensor unit 320 continuously measures the internal temperature of the cooling box 200. The temperature logger 300 stores the measured temperature as the measurement information in the storage unit 314 by being associated with the time when measuring the temperature. The measurement information may contain the identifier for identifying the temperature logger 300.

In SQ101, the user opens the cover of the first cooling box 200A in which the first temperature logger 300A is installed.

In SQ102, the control unit 312 of the first temperature logger 300A transmits, toward the user terminal 100, the signal containing the self-identifier (the identifier for identifying the first temperature logger 300A) via the communication unit 316. Herein, the cover of the first cooling box 200A is opened, and hence the signal is received by the communication unit 130 of the user terminal 100. When the cover of the first cooling box 200A is not opened, the signal is not received by the communication unit 130 of the user terminal 100.

In SQ103, the control unit 110 of the user terminal 100, upon receiving the signal containing the identifier of the first temperature logger 300A via the communication unit 130, transmits to the first temperature logger 300A a signal (request signal) for requesting the transmission of the measurement information containing the temperature data and the time data through the communication unit 130. The first temperature logger 300A receives the request signal from the user terminal 100 via the communication unit 316.

In SQ104, the control unit 312 of the first temperature logger 300A, upon receiving the request signal via the communication unit 316, transmits the measurement information containing the temperature data stored in the storage unit 314 and the time data associated with the temperature data to the user terminal 100 via the communication unit 316. The control unit 110 of the user terminal 100 receives the measurement information containing the temperature data and the time data via the communication unit 130.

Operations in SQ102 through SQ104 are executable in a time well shorter than the time till closing the cover after putting in and taking out the foods and other equivalent items since the user of the user terminal 100 has opened the cover of the cooling box 200.

In SQ105, the control unit 110 of the user terminal 100 stores the received measurement information containing the temperature data and the time data together with the identifier of the first temperature logger 300A in the storage unit 120. The control unit 110 of the user terminal 100 stores, in the storage unit 120, the present time as the time when opening the cover of the cooling box 200 in which the first temperature logger 300A is installed.

The control unit 110 of the user terminal 100 may display such a prompt on the output unit 140 as to input the identifier of the first cooling box 200A with the cover being opened. The identifier of the first cooling box 200 is a unique identifier allocated beforehand to the cooling box 200. The identifier of the first cooling box 200 is previously described, e.g., in the cooling box 200. Hereat, the control unit 110 of the user terminal 100 may accept the input of the identifier of the first cooling box 200A by using the input unit 150. The control unit 110 of the user terminal 100 stores, when the identifier of the first cooling box 200A is inputted, the inputted identifier in the storage unit 120 by being associated with the identifier of the first temperature logger 300A. The temperature control system 10 is thereby enabled to control the internal temperature of the first cooling box 200A in which the first temperature logger 300A is installed. Herein, the identifier of the first cooling box 200A may be replaced by an identifier of one of the foods taken out of the first cooling box 200A (or the foods put into the first cooling box 200A) and other equivalent items. In this case, the temperature control system 10 is enabled to control temperatures of the foods having the temperatures measured by the first temperature logger 300A. The user terminal 100 starts the communications with the first temperature logger 300A upon opening the cover of the first cooling box 200A.

An operation sequence in SQ106 through SQ110 is a sequence when opening the second cooling box 200B. The operation sequence when opening the second cooling box 200B is the same as the operation sequence (SQ101 through SQ105) when opening the first cooling box 200A. The repetitive description thereof is herein omitted.

The user terminal 100 is thereby enabled to acquire the internal temperature data (a history of temperatures) of the cooling box 200 when opening the cover of this cooling box 200. The user of the user terminal 100, when opening the cover, inputs the identifier of the cooling box 200 with the cover being opened and is thereby enabled to make it easy to associate the cooling box 200 and the temperature logger 300 with each other. The user terminal 100 performs the communications with the temperature logger 300 installed in the cooling box 200 when the cover of the cooling box 200 remains opened. The user terminal 100 does not perform the communications with the temperature logger 300 installed in the cooling box 200 when the cover of the cooling box 200 remains closed.

<Operation of User Terminal>

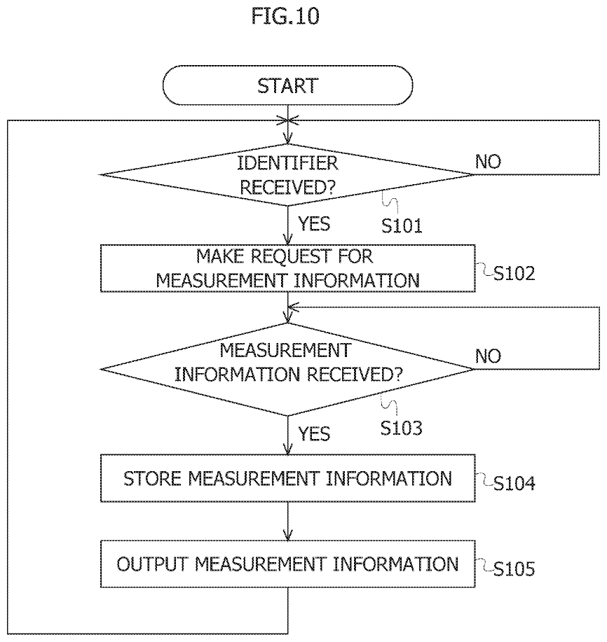

FIG. 10 is a flowchart illustrating an example of an operation flow of the user terminal. The user terminal 100 is carried by the driver (user) of the transport truck for transporting the cooling box 200 containing the foods and other equivalent items.

In S101, the control unit 110 of the user terminal 100 checks whether the communication control unit 130 receives the signal containing the identifier of the temperature logger 300. When receiving the signal (S101; YES), the processing proceeds to S102. Whereas when not receiving the signal (S101; NO), the process in S101 is iterated.

In S102, the control unit 110 of the user terminal 100, when receiving the signal containing the identifier of the temperature logger 300 via the communication control unit 130, transmits to the temperature logger 300 a signal (request signal) for requesting the transmission of the measurement information containing the temperature data via the communication control unit 130.

In S103, the control unit 110 of the user terminal 100 checks whether the communication control unit 130 receives the signal containing the temperature data from the temperature logger 300. When receiving the signal (S103; YES), the processing proceeds to S104. Whereas when not receiving the signal (S103; NO), the process in S103 is iterated.

In S104, the control unit 110 of the user terminal 100 receives the signal containing the measurement information containing the temperature data and the time data indicating the time when measuring the temperature via the communication control unit 130. The control unit 110 of the user terminal 100 stores, in the storage unit 120, the measurement information containing the temperature data and the time data together with the identifier, received in S102, of the temperature logger 300. The control unit 110 of the user terminal 100 stores, in the storage unit 120, the present time as the time when opening the cover of the cooling box 200 in which the temperature logger 300 is installed (the time when the cover is opened and closed).

The control unit 110 of the user terminal 100 may display such a prompt on the output unit 140 as to input the identifier of the cooling box 200 with the cover being opened. Hereat, the control unit 110 of the user terminal 100 may accept the input of the identifier of the cooling box 200 through the input unit 150. The control unit 110 of the user terminal 100, when the user inputs the identifier of the cooling box 200, stores the inputted identifier and the identifier of the temperature logger 300 by being associated with each other in the storage unit 120. The temperature control system 10 is thereby enabled to control the internal temperature of each cooling box 200 in which the temperature logger 300 is installed. The identifier of the cooling box 200 may be replaced by the identifier of each of the foods (or the foods put into the cooling box 200) and other equivalent items taken out of the cooling box 200 with the cover being opened.

In S105, the control unit 110 of the user terminal 100 causes the output unit 140 to display the temperature data contained in the measurement information acquired from the temperature logger 300 together with the time data indicating the time when measuring the temperature. The output unit 140 displays, on a display and other equivalent displaying devices, the acquired temperature data to the user of the user terminal 100. The user of the user terminal 100 is enabled to check the history of the internal temperatures (timewise variations of the temperature) of the cooling box 200. The control unit 110 of the user terminal 100 may get the time when opening the cover of the cooling box 200 to be displayed. The user checks the temperature history and is thereby enabled to assure, e.g., qualities of the foods and other equivalent items put into the cooling box 200 and to determine disposal of the foods and other equivalent items. The control unit 110 may transmit the temperature data and other equivalent data to other information processing apparatuses instanced by the servers via the communication control unit 130.

<Operation of Temperature Logger>

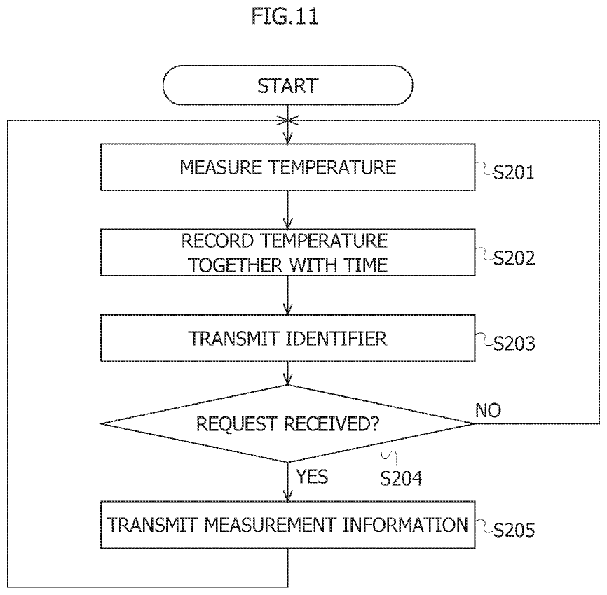

FIG. 11 is a flowchart illustrating an example of an operation flow of the temperature logger. The temperature logger 300 is installed in the interior of the cooling box 200.

In S201, the control unit 312 of the temperature logger 300 measures the ambient temperature by use of the sensor unit 320. The temperature may also be measured at an interval of predetermined time (e.g., at every one minute).

In S202, the control unit 312 of the temperature logger 300 stores the measured temperature together with the time (present time) when measuring the temperature in the storage unit 314.

In S203, the control unit 312 of the temperature logger 300 transmits the signal containing the self-identifier (the identifier for identifying the temperature logger 300) to the user terminal 100 via the communication control unit 316. This signal is not received by the user terminal 100 when the cover of the cooling box 200 remains closed.

In S204, the control unit 312 of the temperature logger 300 checks whether the communication control unit 316 receives the signal (request signal) for requesting the transmission of the measurement information containing the temperature data from the user terminal 100. When receiving the signal (S204; YES), the processing proceeds to S205. Whereas when not receiving the signal (S204; NO), the processing loops back to S201.

In S205, the control unit 312 of the temperature logger 300 transmits the measurement information containing the temperature data stored in the storage unit 314 and the time data associated with the temperature data to the user terminal 100 via the communication control unit 316. Thereafter, the processing loops back to S201.

The temperature logger 300 is thereby enabled to measure the internal temperature of the cooling box 200 and to transmit the temperature data and other equivalent data to the user terminal 100 when opening the cover of the cooling box 200.

The temperature logger 300 may transmit the measurement information containing the temperature data indicating the measured temperature while continuously measuring the internal temperature of the cooling box 200. The measurement information is transmitted to the outside when opening the cover of the cooling box 200. Hereat, the user terminal 100 may receive the measurement information from the temperature logger 300 without transmitting the request signal for requesting the transmission of the measurement information. The user terminal 100 is able to acquire the measurement information (the temperature history) of the cooling box 200 with the cover being opened by the user. Hereat, it is apparent that the measurement information received by the user terminal 100 is the measurement information of the cooling box 200 with the cover being opened by the user, and hence the temperature logger 300 may not transmit the identifier for identifying the temperature logger 300.

### Operation and Effect of Embodiment

The temperature control system 10 controls the internal temperature of the cooling box 200 into which the foods and other equivalent items are put. The temperature logger 300 measures the internal temperature of the cooling box 200. The internal temperature of the cooling box 200 may be deemed to be a temperature of the foods and other equivalent items as a whole. When the user of the user terminal 100 takes the foods and other equivalent items out of the cooling box 200, the user terminal 100 acquires the temperature data from the temperature logger 300. The user terminal 100 outputs the acquired temperature data, thereby enabling the user to check the temperature history of the foods and other equivalent items. The cooling box 200 into which the foods and other equivalent items are put may be transported by the transport truck and other equivalent vehicles. Hereat, for example, the user (the driver of the transport truck) of the user terminal 100 is enabled to check the temperature history of the foods and other equivalent items when transported to a recipient of the foods and other equivalent items.

The temperature logger 300 is disposed within the cooling box 200, and measures the temperature of the containing space of the cooling box 200. The temperature logger 300 is enabled to perform the communications with the devices outside the cooling box 200 when opening the cover of the cooling box 200. The temperature logger 300 transmits the measurement information containing the temperature data to the user terminal 100 when the cover of the cooling box 200 remains opened. The user terminal 100 is enabled to acquire the internal temperature history of the cooling box 200 with the cover being opened by the user.

The temperature control system 10 is enabled to acquire the internal temperature history of the cooling box 200 and to obtain the time when opening the cover of the cooling box 200. The cooling box 200 is opened when the driver of the transport truck or another equivalent vehicle hands over the foods and other equivalent items to the recipient. Therefore, the temperature control system 10 associates the time when handing over the foods and other equivalent items to the recipient with the time when opening the cover of the cooling box 200, and is thereby enabled to acquire the temperature history of the foods and other equivalent items. Hereat, the information indicating which foods and other equivalent items are associated with which cooling box 200 containing these foods and other equivalent items, enables the temperature control system 10 to associate the temperature logger 300 with cooling box that stores this temperature logger 300.

The configurations of the embodiment and other equivalent examples described above may be carried out by being combined to the greatest possible degree.

<Non-Transitory Computer Readable Recording Medium>

A programmaking a computer, other machines and apparatuses (which will hereinafter be referred to as the computer and other equivalents) attain any one of the functions, can be recorded on a non-transitory recording medium readable by the computer and other equivalents. The computer and other equivalents are made to read and run the program on this non-transitory recording medium, whereby the function thereof can be provided.

Herein, the non-transitory recording medium readable by the computer and other equivalents connotes a non-transitory recording medium capable of accumulating information instanced by data, programs and other equivalents electrically, magnetically, optically, mechanically or by chemical action, which can be read from the computer and other equivalents. In such a non-transitory recording medium, computer building components instanced by the CPU and the memory are provided, and the CPU thereof may be made to run the program.

Among these non-transitory recording mediums, the mediums removable from the computer and other equivalents are exemplified by a flexible disc, a magneto-optic disc, a CD-ROM, a CD-R/W, a DVD, a DAT, an 8 mm tape, and a memory card.

A hard disc, a ROM and other equivalents are given as the non-transitory recording mediums fixed within the computer and other equivalents.

### BRIEF DESCRIPTION OF REFERENCE NUMERALS AND SYMBOLS

10 temperature control system
90 computer
91 processor
92 memory
93 storage unit
94 input unit
95 output unit
96 communication control unit
100 user terminal
110 control unit
120 storage unit
130 communication unit
140 output unit
150 input unit
200 cooling box
200A first cooling box
200B second cooling box
210 bottom surface portion
211 front edge portion
212 right edge portion
213 rear edge portion
214 left edge portion
220 front surface portion
221 lower edge portion
222 right edge portion
223 upper edge portion
224 left edge portion
225 hole portion
226 groove portion
230 right side surface
231 lower edge portion
232 front edge portion
233 upper edge portion
234 rear edge portion
240 back surface portion
241 lower edge portion
242 right edge portion
243 upper edge portion
244 left edge portion
250 left side surface
251 lower edge portion
252 front edge portion
253 upper edge portion
254 rear edge portion
260 upper surface portion
261 front edge portion
262 right edge portion
263 rear edge portion
264 left edge portion
300 temperature logger
300A first temperature logger
300B second temperature logger
310 body unit
312 control unit
314 storage unit
316 communication unit
318 power unit
320 sensor unit
330 connection cable

1. A container comprising:
a cover portion;
a box body including; a containing space formed therein; and an opening surface openable and closable by the cover portion; and
a recording device including: a storage unit storing measurement information containing an internal temperature of the containing space and time when measuring the temperature; and a communication unit transmitting the measurement information to an external device, the recording device being provided in the cover portion, or the box body, or within the containing space,
outside surfaces of the cover portion and the box body being covered with a metallic material to block communications between the communication unit and the external device,
the metallic material used blocking of the communications between the communication unit and the external device being cancelled upon opening the cover portion.

2. The container according to claim 1, wherein a recessed portion is formed in one of edge surfaces, contacting the cover portion when closing the cover portion and configuring an opening of the opening surface, of wall portions of the box body, and
the recording device is stored in the recessed portion.

3. The container according to claim 2, wherein the recording device includes a power source to supply electric power to respective units including the storage unit and the communication unit,
the cover portion and the wall portions of the box body have vacuum layers in areas not interfering with the recessed portion,
the recessed portion is formed on the edge surface but outwardly of positions in which the vacuum layers are formed under the edge surface, and
at least the power source is stored in the recessed portion.

4. The container according to claim 3, wherein the cover portion and the wall portions of the box body have a 3-layered structure in which a non-metallic inside heat insulating member, a vacuum heat insulating member having the vacuum layer and a non-metallic outside heat insulating member are disposed toward outside from a side of the containing space, and
the recessed portion is provided in the outside heat insulating member.

5. The container according to claim 1, wherein the communication unit transmits a signal containing an identifier for identifying the recording device and, when receiving a signal requesting the measurement information from the external device, transmits the measurement information to the external device.

6. The container according to claim 1, wherein the recording device includes a sensor unit provided within the containing space and measuring the internal temperature of the containing space.

7. A temperature control system including a plurality of containers and a user terminal, comprising:
a cover portion;
a box body including; a containing space formed therein; and an opening surface openable and closable by the cover portion; and
a recording device including: a storage unit storing measurement information containing an internal temperature of the containing space and time when measuring the temperature; and a communication unit transmitting the measurement information to the user terminal, the recording device being provided in the cover portion or the box body, or within the containing space,
outside surfaces of the cover portion and the box body being covered with a metallic material to block communications between the communication unit and the user terminal,
the metallic material enabling the communications between the communication unit and the user terminal upon opening the cover portion, the user terminal including:
a terminal communication unit receiving the measurement information from the recording device; and
a terminal storage unit storing the measurement information received from the recording device.

8. The temperature control system according to claim 7, wherein the communication unit of the recording device transmits a signal containing an identifier for identifying the recording device and, when receiving a signal requesting the measurement information from the user terminal, transmits the measurement information to the user terminal,
the terminal communication unit of the user terminal transmits, when receiving the signal containing the identifier for identifying the recording device, a signal requesting the measurement information to the recording device, and receives the measurement information from the recording device, and
the terminal storage unit of the user terminal stores the identifier for identifying the recording device and the measurement information by being associated with each other.
